(19) United States
(12) Patent Application Publication
(10) Pub. No.: US 2022/0285990 A1
(43) Pub. Date: Sep. 8, 2022

(54) SYSTEM AND METHOD FOR WIRELESS CHARGING AND MAGNETIC COMMUNICATION

(71) Applicant: Cypress Semiconductor Corporation, San Jose, CA (US)

(72) Inventors: Kamesh Medapalli, San Jose, CA (US); Victor Simileysky, San Jose, CA (US); Kiran Uln, Pleasanton, CA (US)

(73) Assignee: Cypress Semiconductor Corporation, San Jose, CA (US)

(21) Appl. No.: 17/577,766

(22) Filed: Jan. 18, 2022

Related U.S. Application Data
(60) Provisional application No. 63/155,611, filed on Mar. 2, 2021.

(51) Int. Cl. H02J 50/12; H02J 50/80; H02J 50/40; H02J 7/00

(52) U.S. Cl. CPC H02J 50/12; H02J 50/80; H02J 50/40; H02J 7/00034

(57) ABSTRACT

One or more computing devices, systems, and/or methods are provided. In an example, a charging apparatus includes a charging surface, a magnetic charging interface comprising a magnetic charging element configured to generate a charging signal proximate the charging surface, and a magnetic communication interface separate from the magnetic charging interface. A processor is configured to execute instructions to receive a charging parameter using the magnetic communication interface and to control the charging signal via the charging element during a charging session based on the charging parameter.

### RELATED APPLICATION

This application claims priority to U.S. Provisional Application Ser. No. 63/155,611 filed on Mar. 2, 2021, which is incorporated herein by reference.

### BACKGROUND

Internet of Things (“IoT”) technology refers to a wide range of physical objects or devices that have specific defined functions. An IoT device may have wireless communication interfaces for communicating with other devices and wireless charging interfaces for charging batteries of the IoT device.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In an embodiment of the techniques presented herein, a charging apparatus is provided. The charging apparatus comprises a charging surface, a magnetic charging interface comprising a magnetic charging element configured to generate a charging signal proximate the charging surface, a magnetic communication interface separate from the magnetic charging interface, and a processor configured to execute instructions to receive a charging parameter using the magnetic communication interface and to control the charging signal via the charging element during a charging session based on the charging parameter.

In an embodiment of the techniques presented herein, a system comprises means for receiving a charging parameter using a magnetic communication interface of a charging apparatus and means for generating a charging signal proximate a charging surface of the charging apparatus during a charging session based on the charging parameter using a magnetic charging element separate from the magnetic communication interface.

In an embodiment of the techniques presented herein, a method comprises receiving a charging parameter using a magnetic communication interface of a charging apparatus and generating a charging signal proximate a charging surface of the charging apparatus during a charging session based on the charging parameter using a magnetic charging element separate from the magnetic communication interface.

In an embodiment of the techniques presented herein, a non-transitory computer-readable medium stores instructions that when executed facilitate performance of operations comprising receiving a charging parameter using a magnetic communication interface of a charging apparatus and generating a charging signal proximate a charging surface of the charging apparatus during a charging session based on the charging parameter using a magnetic charging element separate from the magnetic communication interface.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a diagram illustrating a charging apparatus for providing wireless charging and communication services to one or more devices, in accordance with some embodiments.

FIG. 2 is a block diagram of the processing complex of the charging apparatus interfacing with a device, in accordance with some embodiments.

FIG. 3 is a block diagram illustrating an arrangement between a wireless charging interface of the charging apparatus and a wireless charging interface of the device, in accordance with some embodiments.

FIG. 4 is a block diagram illustrating a magnetic communication interface, in accordance with some embodiments.

FIGS. 5-7 are diagrams illustrating the charging apparatus interfacing with devices, in accordance with some embodiments.

FIG. 8 is a diagram illustrating a method for charging a device, in accordance with some embodiments.

FIG. 9 illustrates an exemplary embodiment of a computer-readable medium, in accordance with some embodiments.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

It is to be understood that the following description of embodiments is not to be taken in a limiting sense. The scope of the present disclosure is not intended to be limited by the embodiments described hereinafter or by the drawings, which are taken to be illustrative only. The drawings are to be regarded as being schematic representations and elements illustrated in the drawings are not necessarily shown to scale. Rather, the various elements are represented such that their function and general purpose become apparent to a person skilled in the art.

All numerical values within the detailed description and the claims herein are modified by “about” or “approximately” the indicated value, and take into account experimental error and variations that would be expected by a person having ordinary skill in the art.

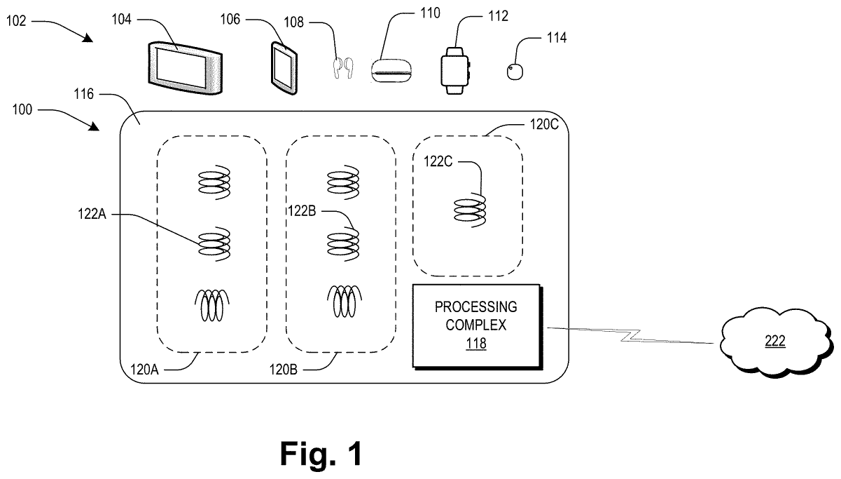

FIG. 1 is a diagram illustrating a charging apparatus 100 for providing wireless charging and communication services to one or more devices 102, in accordance with some embodiments. In some embodiments, the devices 102 include one or more of a tablet 104, a smartphone 106, earbuds 108, an earbud case 110, a smartwatch 112, a tracker device 114, or some other suitable device, such as an IoT device, that supports wireless charging. Trends in device manufacturing include removing external jacks or interfaces on the devices 102 to reduce device size, increase damage resistance, and support alternative cooling schemes. For example device cooling systems using a liquid or vapor cooling medium are hindered by openings in the outer casing of a device 102.

In some embodiments, the charging apparatus 100 comprises a charging surface 116 for interfacing with the one or more devices 102, and a processing complex 118 for controlling the charging surface 116 and communicating with the devices 102. The one or more devices 102 may be placed on the charging surface 116 to facilitate wireless charging of the device 102 using a magnetic charging interface that generates a charging signal proximate the charging surface 116. In some embodiments, the charging surface 116 is a charging mat, a surface of a tablet, a surface of a charging station, or some other suitable charging surface to facilitate wireless charging.

In some embodiments, the charging surface 116 is divided into charging zones 120A, 120B, 120C. In some embodiments, each charging zone 120A, 120B, 120C comprises one or more magnetic charging elements 122A, 122B, 122C to support magnetic charging of devices 102 placed in the charging zone 120A, 120B, 120C. In some embodiments, the processing complex 118 controls each charging zone 120A, 120B, 120C. In some embodiments, the processing complex 118 dynamically generates the boundaries of the charging zones 120A, 120B, 120C by assigning the one or more magnetic charging elements 122A, 122B, 122C to the charging zones 120A, 120B, 120C. The magnetic charging elements 122A, 122B, 122C may have different orientations to allow for charging optimization or magnetic beamforming. The boundaries of the charging zones 120A, 120B, 120C may change depending on the particular devices 102 placed in the charging zones 120A, 120B, 120C, the charging state of the devices 102, associations between the devices 102, user preferences, or based on other suitable parameters.

In some embodiments, the boundaries of the charging zones 120A, 120B, 120C are physically marked on the charging surface 116. In an embodiment where the charging surface 116 comprises a display, the boundaries of the charging zones 120A, 120B, 120C may be dynamically drawn on the display of the charging surface 116. The number of charging zones 120A, 120B, 120C and the number of devices 102 supported by the charging apparatus may vary from a few charging zones 120A, 120B, 120C and devices 102 to tens or hundreds of devices 102 or charging zones 120A, 120B, 120C.

In some embodiments, status information regarding the devices 102 or the charging zones 120A, 120B, 120C is provided on the display of the charging surface 116. The status information may include charging state, charging time, communication status, job status associated with a process executing on one of the devices 102, or some other suitable status information.

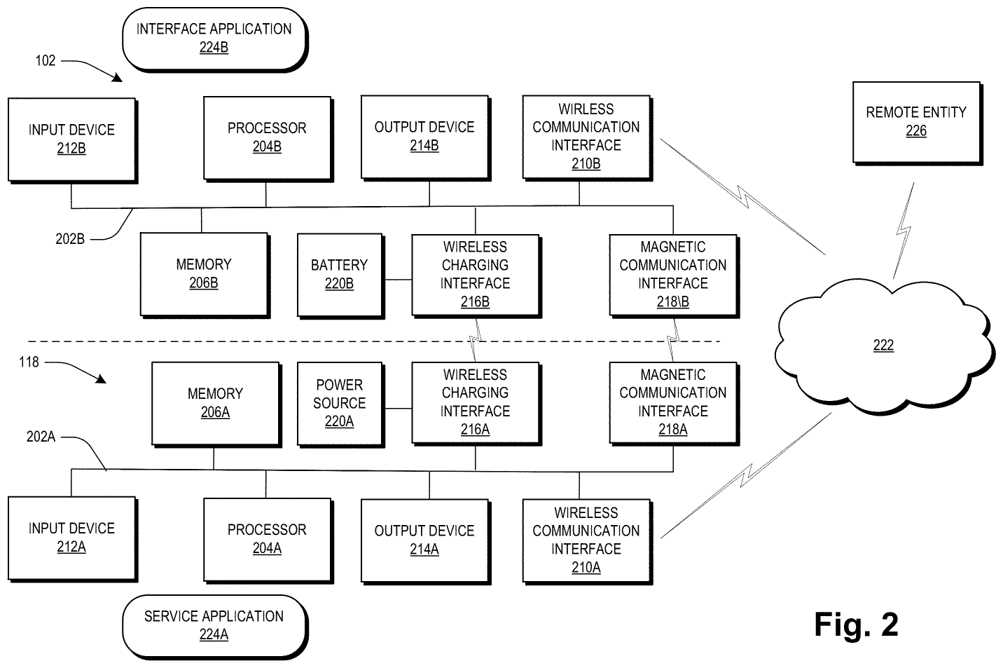

Referring to FIG. 2, a block diagram of the processing complex 118 of the charging apparatus 100 interfacing with a device 102 is provided, in accordance with some embodiments. In some embodiments, the processing complex 118 comprises a bus 202A, a processor 204A, a memory 206A that stores software, a wireless communication interface 210, an input device 212A, an output device 214A, a wireless charging interface 216A, a magnetic communication interface 218A, and a power source 220A. The processing complex 118 may include fewer components, additional components, different components, and/or a different arrangement of components than those illustrated in FIG. 2.

In some embodiments, the device 102 comprises a bus 202B, a processor 204B, a memory 206B that stores software, a wireless communication interface 1106, an input device 212B, an output device 214B, a wireless charging interface 216B, a magnetic communication interface 2186, and a battery 220B. The device 102 may include fewer components, additional components, different components, and/or a different arrangement of components than those illustrated in FIG. 2. The operation of the components of the device 102, such as the bus 202B, the processor 204B, the memory 206B, the wireless communication interface 1106, the input device 212B, the output device 214B, the wireless charging interface 216B, and the magnetic communication interface 218B may be similar to the operations described for the components with corresponding reference numerals in the processing complex 118, however, the particular structures and functions may differ. Additional hardware or software applications may be employed to support the specific functionality of the device 102.

According to some embodiments, the bus 202A includes a path that permits communication among the components of the processing complex 118. For example, the bus 202A may include a system bus, an address bus, a data bus, and/or a control bus. The bus 202A may also include bus drivers, bus arbiters, bus interfaces, clocks, and so forth. The processor 204A includes one or multiple processors, microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. The processor 204A may be implemented as hardware (e.g., a microprocessor, etc.), a combination of hardware and software (e.g., a SoC, an ASIC, etc.), may include one or multiple memories (e.g., cache, etc.), etc.

In some embodiments, the processor 204A controls the overall operation or a portion of the operation(s) performed by the charging apparatus 100. The processor 204A performs one or multiple operations based on an operating system and/or various applications or computer programs (e.g., software). The processor 204A accesses instructions from the memory 206A, from other components of the processing complex 118, and/or from a source external to the charging apparatus 100 (e.g., a network, another device, etc.). The processor 204A may perform an operation and/or a process based on various techniques including, for example, multithreading, parallel processing, pipelining, interleaving, etc.

In some embodiments, the memory 206A includes one or multiple memories and/or one or multiple other types of storage mediums. For example, the memory 206A may include one or multiple types of memories, such as, random access memory (RAM), dynamic random access memory (DRAM), cache, read only memory (ROM), a programmable read only memory (PROM), a static random access memory (SRAM), a single in-line memory module (SIMM), a dual in-line memory module (DIMM), a flash memory, and/or some other suitable type of memory. The memory 206A may include a hard disk, a magnetic disk, an optical disk, a magneto-optic disk, a solid state disk, a Micro-Electromechanical System (MEMS)-based storage medium, a nanotechnology-based storage medium, and/or some other suitable disk. The memory 206A may include drives for reading from and writing to the storage medium. The memory 206A may be external to and/or removable from charging apparatus 100, such as, for example, a Universal Serial Bus (USB) memory stick, a dongle, a hard disk, mass storage, off-line storage, or some other type of storing medium (e.g., a compact disk (CD), a digital versatile disk (DVD), a Blu-Ray disk (BD), etc.). The memory 206A may store data, software, and/or instructions related to the operation of the charging apparatus 100.

The wireless communication interface 210 permits the charging apparatus 100 to communicate with other devices, networks, systems, sensors, and/or the like on a network 222. The wireless communication interface 210 may include one or multiple wireless interfaces and/or wired interfaces. For example, the wireless communication interface 210 may include one or multiple transmitters and receivers, or transceivers. The wireless communication interface 210 may operate according to a protocol stack and a communication standard. In some embodiments, the wireless communication interface 210 includes an antenna. The wireless communication interface 210 may include various processing logic or circuitry (e.g., multiplexing/de-multiplexing, filtering, amplifying, converting, error correction, etc.). In some embodiments, the wireless communication interface 210 operates using a long range wireless protocol, such as a cellular protocol or a WiFi protocol, a short range protocol, such as BLUETOOTH™, or a wired protocol, such as Ethernet.

In some embodiments, the input device 212A permits an input into the charging apparatus 100. For example, the input device 212A may comprise a keyboard, a mouse, a display, a touchscreen, a touchless screen, a button, a switch, an input port, speech recognition logic, and/or some other type of suitable visual, auditory, or tactile input component. The output device 214A permits an output from the charging apparatus 100. For example, the output device 214A may include a speaker, a display, a touchscreen, a touchless screen, a projected display, a light, an output port, and/or some other type of suitable visual, auditory, or tactile output component.

In some embodiments, the functionalities of the input device 212A and/or the output device 214A are provided by the input device 212B and/or the output device 214B of the device 102. For example, the charging apparatus 100 may not have input/output interfaces for user interaction. A user may initiate a connection between the device 102 and the charging apparatus 100 using an interface application 224B executing on the device 102. After appropriate security authentication, the user may employ the software application on the device 102 to access data associated with the charging apparatus 100, configure the charging apparatus 100, or perform some other input or output function on the charging apparatus 100.

The wireless charging interface 216A of the charging apparatus 100 generates a charging signal that is received by the wireless charging interface 216B of the device 102 to provide power from the power source 220A to the device 102 to charge the battery 220B. In some embodiments, the power source 220A comprises a DC power source. For example, the charging apparatus 100 may be connected to an external power source, such as an AC outlet. A voltage converter in the power source 220A may generate a DC voltage based on the external power source. In some embodiments, the power source 220A comprises a battery suitable for charging the one or more devices 102 in the absence of the external power source.

In some embodiments, the wireless charging interface 216A of the charging apparatus is separate from the charging surface 116. For example, the wireless charging interface 216A may be a magnetic beamforming device that sends a magnetic charging signal to the wireless charging interface 216B of the device 102 from a different location in a room than the charging surface 116, such as from the ceiling.

The magnetic communication interface 218A of the charging apparatus 100 communicates with the magnetic communication interface 2186 of the device 102 using a sort range magnetic communication protocol. In some embodiments, the processing complex 118 includes multiple magnetic communication interfaces 218A at different positions on the charging surface 116 to facilitate communication with devices 102 in various locations, such as where the size of the charging surface 116 exceeds the range of a single magnetic communication interface 218A. In some embodiments, the magnetic communication interfaces 218A, 218B provide a high bandwidth communication pathway between the device 102 and the charging apparatus 100 and between associated devices 102. In some embodiments, the magnetic communication interfaces 218A, 218B establish a mesh network including the charging apparatus 100 and associated devices 102.

In some embodiments, the processing complex 118 executes a service application 224A that controls the operation of the charging apparatus 100 for charging and/or communicating with the devices 102. For example, the service application 224A may control the charging provided by the wireless charging interfaces 216A, 216B by changing the characteristics of the power exchange, such as by implementing resonant frequency matching, magnetic field alignment, impedance matching, charging power, or some other charging parameter to increase the efficiency of the charging of the devices 102. In some embodiments, each charging zone 120A, 120B, 120C is controlled separately and the charging zones 120A, 120B, 120C may be redefined to support changes in the charging provided if two devices 102 in the same charging zone 120A, 120B, 120C require different charging parameters. The exchange of charging data can result in an increase of the wireless charging operation. For example, typical wireless charging efficiency is around 70%. Controlling the charging zones 120A, 120B, 120C as described herein can increase the wireless charging efficiency to around 90%, comparable to wired charging efficiency of around 95%.

To facilitate efficient charging, the charging apparatus 100 and the devices 102 exchange data using the high bandwidth pathway provided by the magnetic communication interfaces 218A, 218B, respectively. For example, prior to charging the devices 102 may send device configuration data to the service application 224A, such as charging state, required power, current limits, device capabilities, authentication parameters, or some other appropriate device information. As the charge state of the device 102 changes, the service application 224A may be updated regarding different charging parameters or preferences. The high bandwidth communication pathway provided by the magnetic communication interfaces 218A, 218B supports efficient and dynamic charging regulation. The wireless charging interface 216A and the magnetic communication interface 218A are implemented as independent devices to separate the charging function from the communication function and thus avoid data bandwidth restrictions and/or data type limits. It is to be appreciated that high bandwidth implementations as provided herein afford at least some benefits not achievable utilizing low bandwidth. For example, high bandwidth implementations allow sufficient data to be communicated such that charging can be managed effectively and/or efficiently. Also, with high bandwidth implementations, the types of data that may be communicated may be less restricted, such as due to standards and/or regulatory issues.

In some embodiments, the service application 224A retrieves charging parameters for the device 102 from a remote entity 226 on the network 222. For example, the service application 224A may retrieve device capability information, local interference parameters for the device 102, or some other device parameter from the remote entity 226 based on a device type (e.g., manufacturer, model number, etc.)

In some embodiments, the device capability information includes whether the device 102 includes a magnetic communication interface 218B. For example, the service application 224A may receive device type data from the device using the limited communication capabilities of the wireless charging interfaces 216A, 216B.

In some embodiments, the service application 224A sends charging data to the remote entity 226 related to charging sessions with the devices 102. The charging data may be as training data for adapting the charging algorithms for the charging apparatus 100, data for adapting the beamforming techniques of the wireless charging interface 216A. In some embodiments, the remote entity 226 comprises a charging controller that uses an intelligence algorithm, such as a machine learning model or artificial intelligence model, to determine charging parameters for the devices 102 on the charging surface 116. For example, the service application 224A may send device parameters, such as identity, orientation on the charging surface 116, charge state, or some other suitable device parameter, and the charging controller on the remote entity 226 may send a charging plan to the service application 224A that provides charging parameters for the devices 102. Example charging parameters include a configuration of the charging zones 120A, 120B, 120C, charging power, impedance matching data, resonant frequency matching data, magnetic field alignment data, or some other suitable charging parameter.

In some embodiments, the service application 224A establishes a high bandwidth pathway for the charging apparatus 100 and the devices 102 to communicate data other than charging data. For example, data traffic for the device communicated using the wireless communication interface 1106 may be metered or bandwidth limited. The wireless communication interface 210 of the charging apparatus 100 may have a higher bandwidth connection to the network 222 than the wireless communication interface 110B of the device 102. For example, the smartphone 106 may communicate with the earbuds 108 using a BLUETOOTH™ protocol. Rather than using the communication interfaces 210B of the smartphone 106 and the earbuds 108, data may be routed over the mesh network implemented by the magnetic communication interfaces 218A, 218B. In another example, data for a software update may be retrieved from the network 222 through the connection between the wireless communication interface 210 of the charging apparatus 100 and the network 222 and provided to the device 102 requiring the update by the magnetic communication interfaces 218A, 218B. The data routed using the magnetic communication interfaces 218A, 218B may be message data, call data, media streaming data, synchronization data, or any other type of data used by the device 102.

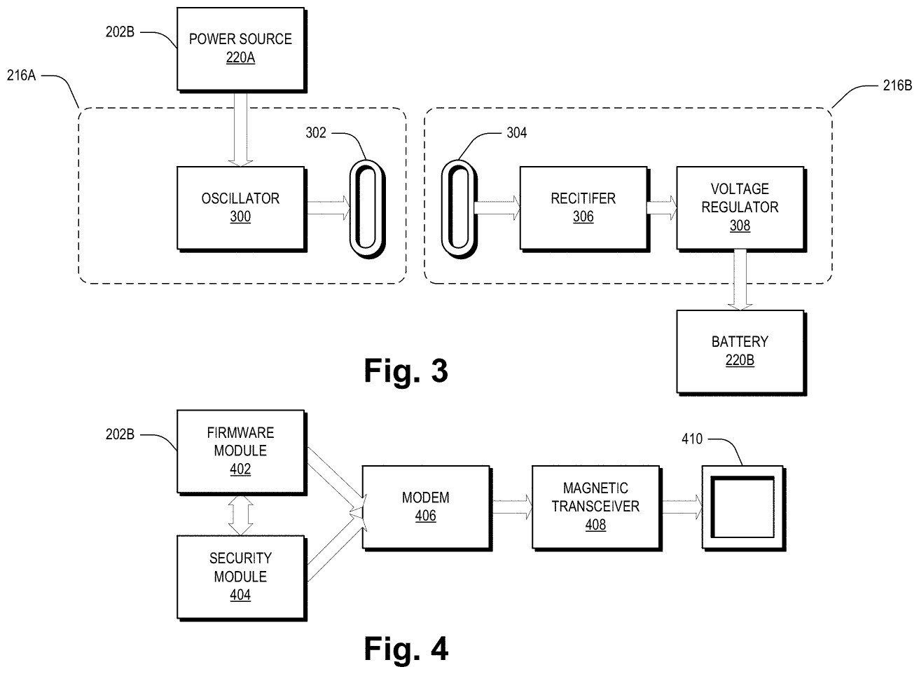

Referring to FIG. 3, a block diagram illustrating the wireless charging interface 216A and the wireless charging interface 216B is provided, in accordance with some embodiments. In some embodiments, the wireless charging interface 216A comprises an oscillator 300 coupled to the power source 220A and a transmitter coil 302, such as one of the magnetic charging elements 122A, 122B, 122C. In some embodiments, the wireless charging interface 216B comprises a receiver coil 304, a rectifier 306, and a voltage regulator 308 coupled to the battery 220B and/or other components of the device 102. The oscillator 300 generates an alternating current in the transmitter coil 302. The alternating current creates a magnetic field fluctuating in strength according to the alternating current magnitude and frequency. The fluctuating magnetic field generated by the transmitter coil 302 induces an alternating current in the receiver coil 304. The rectifier 306, such as half wave rectifier, a full wave rectifier, a bridge rectifier, or other suitable rectifier, rectifies the induced alternating current and the voltage regulator 308 converts the rectified signal into direct current, which may be employed to charge the battery 220B of the device 102 and/or to provide operating power for the device 102.

In some embodiments, the transmitter coil 302 is located in the charging surface 116. In some embodiments, the transmitter coil 302 is a beam forming device that transmits a targeted magnetic signal to the receiver coil 304 through the air. In some embodiments, the receiver coil 304 is housed in the device, such as on a back panel of the tablet 104 or the smartphone 106, on a bottom surface of the earbud case 110, the smartwatch 112, or the tracker device 114, or a side surface of the earbuds 108.

Referring to FIG. 4, a block diagram illustrating a magnetic communication interface 400, such as one of the magnetic communication interfaces 218A, 218B, is provided, in accordance with some embodiments. In some embodiments, the magnetic communication interface 400 comprises a firmware module 402, a security module 404, a modem 406, a magnetic transceiver 408, and an antenna 410.

The firmware module 402 comprises a process and instructions for implementing a protocol stack of the magnetic communication interface 400 to send and receive data. The security module 404, which may be integrated into the firmware module 402, provides security services, such as authentication, encryption, or other security functions for the magnetic communication interface 400. For example, the magnetic communication interface 400 may be configured to communicate only with other devices that have been authenticated, and the security module 404 may handle the authentication and store a list authorized devices on the network established using the magnetic communication interface 400.

The modem 406 modulates upstream data and demodulates downstream data communicated using the magnetic communication interface 400. The magnetic transceiver 408 generates a magnetic data transmission signal that carries the modulated data signal generated by the modem 406 and receives magnetic transmission signals from other devices 102. In some embodiments, the antenna 410 comprises a loop antenna, such as a circular loop antenna or a rectangular loop antenna. Multiple antennas 410 may be used to extend the range of the magnetic communication interface 400. The magnetic transceiver 408 generates a magnetic field in the antenna 410 that is magnetically coupled to a corresponding antenna in another device 102. Received signals generate a magnetic field in the antenna 410 and are received by the magnetic transceiver 408.

In some embodiments, the firmware module 402 aggregates data packets into a single transmission. In some embodiments, the magnetic transceiver 408 operates using a frequency of about 60 GHz, such as between about 55 GHz-75 GHz.

In some embodiments, the magnetic transceiver 408 senses a channel clear condition prior to sending a magnetic transmission. The magnetic transceiver 408 may use different frequencies for communicating with different devices 102. Channel sensing and frequency selection allow for multiple devices 102 to be co-located. In some embodiments, the footprint of the magnetic communication interface 400 allow incorporation into relatively small devices, such as the earbuds 108.

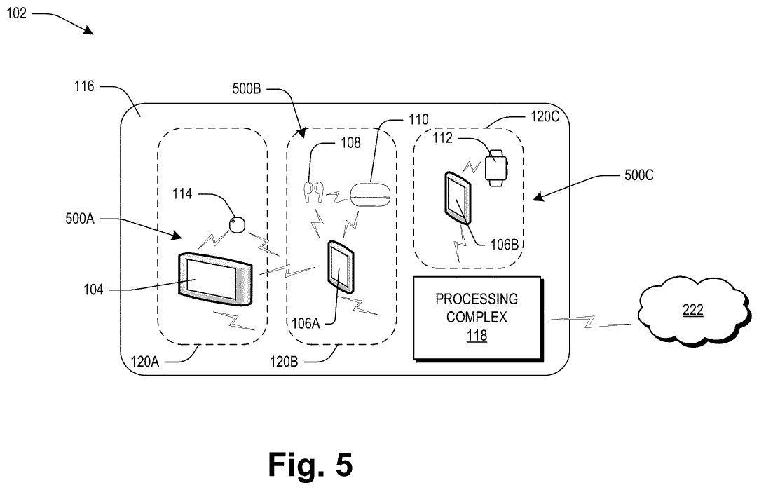

Referring to FIGS. 5-7, diagrams illustrating the charging apparatus 100 interfacing with devices 102 are provided, in accordance with some embodiments. In the example of FIG. 5, a tablet 104 and a tracker device 114 are placed on charging surface 116 in the charging zone 120A, a smartphone 106A, earbuds 108, and an earbud case 110 are placed in the charging zone 120B, and a smartphone 106B and the smartwatch 112 are placed in the charging zone 120C. In some embodiments, the charging zones 120A, 120B, 120C are predefined on the charging surface 116. In some embodiments, the service application 224A establishes the charging zones 120A, 120B, 120C after establishing the associations between the tablet 104 and the tracker device 114, between the smartphone 106A, the earbuds 108, and the earbud case 110, and between the smartphone 106B and the smartwatch 112.

Associations between the devices 102 may be established by a security master, such as one of the devices 102 or the charging apparatus 100 via the service application 224A. For example, the tablet 104 may serve as the security master to authenticate a connection to the tracker device 114 based on pre-established pairing information, such as a BLUETOOTH™ pairing. The tablet 104 may communicate the security association to the service application 224A and the service application 224A may set up the charging zone 120A. Selected devices, such as the smartphone 106A in the charging zone 120B, and the smartphone 106B in the charging zone 120C may serve as security masters to establish associations between the devices 102. In some embodiments, an association may cross charging zones 120A, 120B, 120C. For example, the tablet 104 may be associated with the smartphone 106A and may access the peer network 500A or the peer network 500B.

In some embodiments, the security associations may also be used to set up a peer network 500A that includes the processing complex 118, the tablet 104, and the tracker device 114, a peer network 500B between the smartphone 106A, the earbuds 108 and the earbud case 110, and a peer network 500C between the smartphone 106B and the smartwatch 112. The designated security master and/or the charging apparatus 100 via the service application 224A may communicate identities of allowed devices 102 for each peer network 500A, 500B, 500C.

In some embodiments, the peer networks 500A, 500B, 500C are established using the magnetic communication interfaces 218A, 218B. In some embodiments, the peer network 500 comprises a mesh network. Example mesh network protocols include ZIGBEE™, THREAD™, Z-WAVE™, or some other suitable mesh protocol. In some embodiments, the peer network 500A employs a non-mesh peer network protocol.

Routing data for a device 102 through one of the peer networks 500A, 500B, 500C provides an increased bandwidth or reduced cost compared to communicating via the wireless communication interface 110B or through the wireless charging interface 216B (if equipped for low bandwidth communication).

In some embodiments, the service application 224A dynamically manages the charging zones 120A, 120B, 120C depending on the charging conditions. During the charging of a device 102, the device 102 periodically communicates charging status data, such as state of charge, to the service application 224A. For example, in the charging zone 120B, the earbuds 108 and/or the earbud case 110 may charge more quickly than the smartphone 106A due to smaller batteries. When earbuds 108 and/or the earbud case 110 communicate to the service application 224A that a sufficient charge level has been reached, the service application 224A may modify the charging zone 120B.

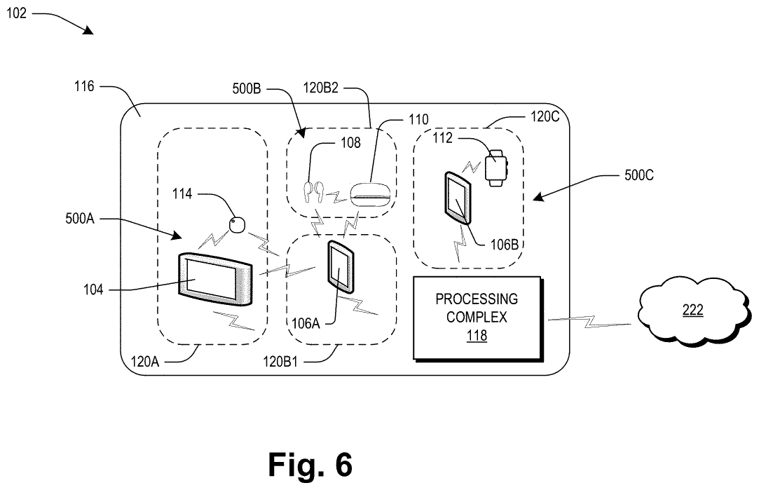

Referring to FIG. 6, the service application 224A divides the charging zone 120B into a charging zones 120B1 including the smartphone 106A and a charging zone 120B2 including the earbuds 108 and the earbud case 110. Although the charging zone 120B is reconfigured, the configuration of the peer network 500B is not changed.

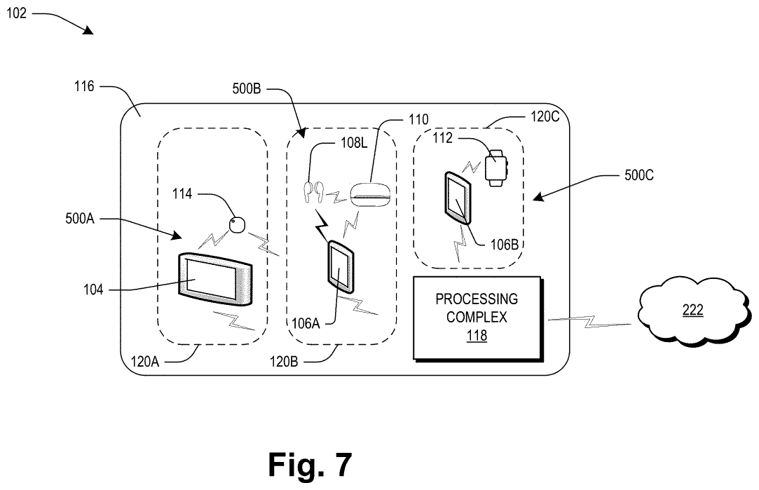

Referring to FIG. 7, in some embodiments, one or more of the devices 102, such as earbuds 108L, may be a legacy device equipped with a wireless charging interface 216B for wireless charging but not with a magnetic communication interface 218B for high bandwidth communication or participation in a peer network 500A, 500B, 500C. The service application 224A may identify the device capabilities through a low bandwidth exchange of identity information using the wireless charging interface 216B. The service application 224A may access the remote entity 226 based on a device type or identification number to determine the device capabilities. The charging apparatus 100 may charge the legacy earbuds 108L using a standard charging profile or one tailored to the device type by the remote entity 226 and not attempt to establish peer connectivity. The legacy earbuds 108L can communicate with another device 102, such as the smartphone 106A, using the wireless communication interface 1106, as indicated by the solid black communication line. The smartphone 106A and the earbud case 110 can still participate in the peer network 500B.

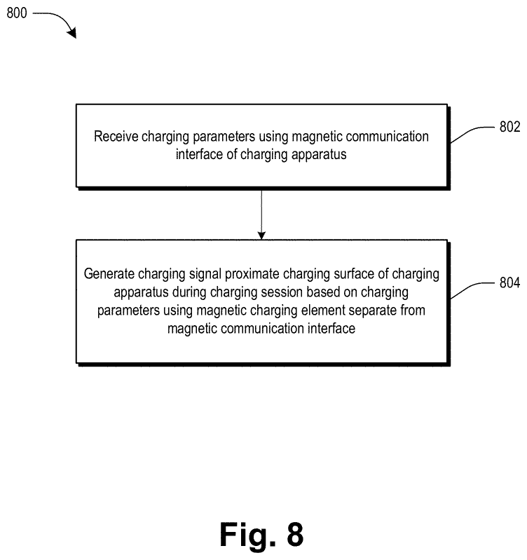

Referring to FIG. 8, a diagram illustrating a method 800 for charging a device is provided, in accordance with some embodiments. At 802, charging parameters are received using a magnetic communication interface 218A of a charging apparatus 100. At 804, a charging signal is generated proximate a charging surface 116 of the charging apparatus 100 during a charging session based on the charging parameters using a magnetic charging element 122 separate from the magnetic communication interface 218A.

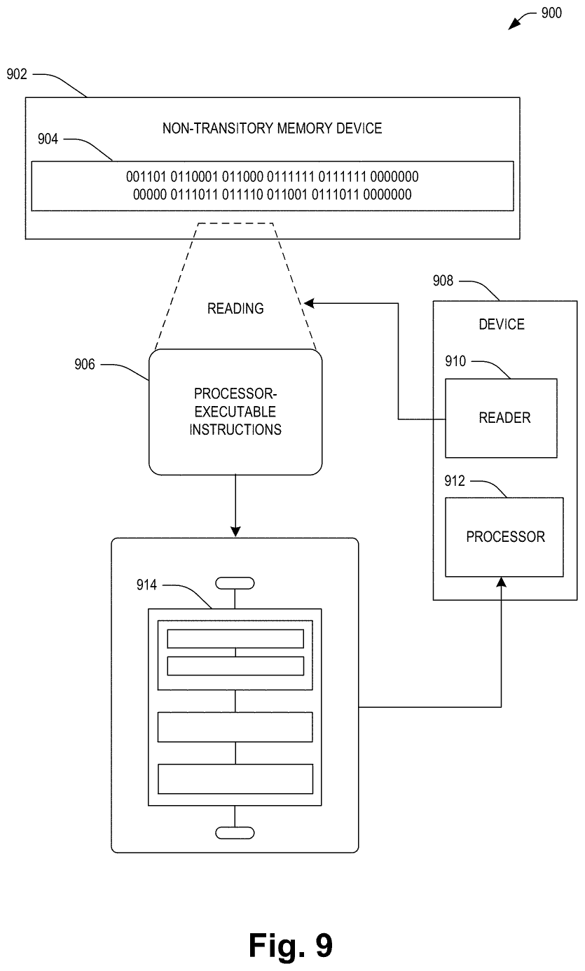

FIG. 9 illustrates an exemplary embodiment 900 of a computer-readable medium 902, in accordance with some embodiments. One or more embodiments involve a computer-readable medium comprising processor-executable instructions configured to implement one or more of the techniques presented herein. The embodiment 900 comprises a non-transitory computer-readable medium 902 (e.g., a CD-R, DVD-R, flash drive, a platter of a hard disk drive, etc.), on which is encoded computer-readable data 904. This computer-readable data 904 in turn comprises a set of processor-executable computer instructions 906 that, when executed by a computing device 908 including a reader 910 for reading the processor-executable computer instructions 906 and a processor 912 for executing the processor-executable computer instructions 906, are configured to facilitate operations according to one or more of the principles set forth herein. In some embodiments, the processor-executable computer instructions 906, when executed, are configured to facilitate performance of a method 914, such as at least some of the aforementioned method(s). In some embodiments, the processor-executable computer instructions 906, when executed, are configured to facilitate implementation of a system, such as at least some of the one or more aforementioned system(s). Many such computer-readable media may be devised by those of ordinary skill in the art that are configured to operate in accordance with the techniques presented herein.

The term “computer readable media” may include communication media. Communication media typically embodies computer readable instructions or other data in a “modulated data signal” such as a carrier wafer or other transport mechanism and includes any information delivery media. The term “modulated data signal” may include a signal that has one or more of its characteristics set or changed in such a manner as to encode information in the signal.

In an embodiment of the techniques presented herein, a charging apparatus is provided. The charging apparatus comprises a charging surface, a magnetic charging interface comprising a magnetic charging element configured to generate a charging signal proximate the charging surface, a magnetic communication interface separate from the magnetic charging interface, and a processor configured to execute instructions to receive a charging parameter using the magnetic communication interface and to control the charging signal via the charging element during a charging session based on the charging parameter.

In an embodiment of the techniques presented herein, the magnetic charging element comprises at least one of a transmitter coil or a magnetic beamforming device.

In an embodiment of the techniques presented herein, the magnetic communication interface comprises a magnetic transceiver configured to communicate a magnetic signal using a frequency of at least about 40 GHz.

In an embodiment of the techniques presented herein, the magnetic communication interface comprises an antenna, a magnetic transceiver coupled to the antenna and configured to communicate a magnetic signal, and a firmware module configured to implement a peer network protocol to communicate using the magnetic transceiver.

In an embodiment of the techniques presented herein, the peer network protocol comprises a mesh network protocol.

In an embodiment of the techniques presented herein, the charging surface comprises a display, and the processor is configured to execute instructions to illustrate a charging zone on the display.

In an embodiment of the techniques presented herein, the charging apparatus comprises a wireless communication interface, wherein the processor is configured to execute instructions to receive data using the wireless communication interface and send the data using the magnetic communication interface.

In an embodiment of the techniques presented herein, the processor is configured to execute instructions to establish a peer network with one or more devices positioned on the charging surface using the magnetic communication interface.

In an embodiment of the techniques presented herein, the processor is configured to execute instructions to implement the charging session with a device positioned on the charging surface and receive charging status data from the device using the magnetic communication interface during the charging session.

In an embodiment of the techniques presented herein, a system comprises means for receiving a charging parameter using a magnetic communication interface of a charging apparatus and means for generating a charging signal proximate a charging surface of the charging apparatus during a charging session based on the charging parameter using a magnetic charging element separate from the magnetic communication interface.

In an embodiment of the techniques presented herein, a method comprises receiving a charging parameter using a magnetic communication interface of a charging apparatus and generating a charging signal proximate a charging surface of the charging apparatus during a charging session based on the charging parameter using a magnetic charging element separate from the magnetic communication interface.

In an embodiment of the techniques presented herein, generating the charging signal during the charging session based on the charging parameter using the magnetic charging element comprises generating the charging signal using at least one of a transmitter coil or a magnetic beamforming device.

In an embodiment of the techniques presented herein, receiving the charging parameter using the magnetic communication interface comprises receiving the charging parameter using a magnetic transceiver configured to communicate a magnetic signal using a frequency of at least about 40 GHz.

In an embodiment of the techniques presented herein, the method comprises implementing a peer network protocol to communicate using the magnetic communication interface.

In an embodiment of the techniques presented herein, implementing the peer network protocol comprises implementing a mesh network protocol.

In an embodiment of the techniques presented herein, the method comprises illustrating a charging zone on a display of the charging surface.

In an embodiment of the techniques presented herein, the method comprises receiving data using a wireless communication interface of the charging apparatus and sending the data using the magnetic communication interface.

In an embodiment of the techniques presented herein, the method comprises establishing a peer network with one or more devices positioned on the charging surface using the magnetic communication interface.

In an embodiment of the techniques presented herein, the method comprises implementing the charging session with a device positioned on the charging surface and receiving charging status data from the device using the magnetic communication interface during the charging session.

In an embodiment of the techniques presented herein, a non-transitory computer-readable medium stores instructions that when executed facilitate performance of operations comprising receiving a charging parameter using a magnetic communication interface of a charging apparatus and generating a charging signal proximate a charging surface of the charging apparatus during a charging session based on the charging parameter using a magnetic charging element separate from the magnetic communication interface.

In an embodiment of the techniques presented herein, the operations comprise establishing a peer network with one or more devices positioned on the charging surface using the magnetic communication interface, implementing the charging session with the one or more devices, and receiving charging status data from the one or more devices using the magnetic communication interface during the charging session.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, unless specified otherwise, “first,” “second,” or the like are not intended to imply a temporal aspect, a spatial aspect, an ordering, etc. Rather, such terms are merely used as identifiers, names, etc. for features, elements, items, etc. For example, a first element and a second element generally correspond to element A and element B or two different or two identical elements or the same element.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A charging apparatus, comprising:
a charging surface;
a magnetic charging interface comprising a magnetic charging element configured to generate a charging signal proximate the charging surface;
a magnetic communication interface separate from the magnetic charging interface; and
a processor configured to execute instructions to receive a charging parameter using the magnetic communication interface and to control the charging signal via the charging element during a charging session based on the charging parameter.

2. The charging apparatus of claim 1, wherein:
the magnetic charging element comprises at least one of a transmitter coil or a magnetic beamforming device.

3. The charging apparatus of claim 1, wherein the magnetic communication interface comprises:
a magnetic transceiver configured to communicate a magnetic signal using a frequency of at least about 40 GHz.

4. The charging apparatus of claim 1, wherein the magnetic communication interface comprises:
an antenna;
a magnetic transceiver coupled to the antenna and configured to communicate a magnetic signal; and
a firmware module configured to implement a peer network protocol to communicate using the magnetic transceiver.

5. The charging apparatus of claim 4, wherein:
the peer network protocol comprises a mesh network protocol.

6. The charging apparatus of claim 1, wherein:
the charging surface comprises a display, and
the processor is configured to execute instructions to illustrate a charging zone on the display.

7. The charging apparatus of claim 1, comprising:
a wireless communication interface, wherein:
the processor is configured to execute instructions to receive data using the wireless communication interface and send the data using the magnetic communication interface.

8. The charging apparatus of claim 1, wherein:
the processor is configured to execute instructions to establish a peer network with one or more devices positioned on the charging surface using the magnetic communication interface.

9. The charging apparatus of claim 1, wherein the processor is configured to execute instructions to:
implement the charging session with a device positioned on the charging surface, and
receive charging status data from the device using the magnetic communication interface during the charging session.

10. A method, comprising:
receiving a charging parameter using a magnetic communication interface of a charging apparatus; and
generating a charging signal proximate a charging surface of the charging apparatus during a charging session based on the charging parameter using a magnetic charging element separate from the magnetic communication interface.

11. The method of claim 10, wherein generating the charging signal during the charging session based on the charging parameter using the magnetic charging element comprises:
generating the charging signal using at least one of a transmitter coil or a magnetic beamforming device.

12. The method of claim 10, wherein receiving the charging parameter using the magnetic communication interface comprises:
receiving the charging parameter using a magnetic transceiver configured to communicate a magnetic signal using a frequency of at least about 40 GHz.

13. The method of claim 10, comprising:
implementing a peer network protocol to communicate using the magnetic communication interface.

14. The method of claim 13, wherein implementing the peer network protocol comprises:
implementing a mesh network protocol.

15. The method of claim 10, comprising:
illustrating a charging zone on a display of the charging surface.

16. The method of claim 10, comprising:
receiving data using a wireless communication interface of the charging apparatus; and
sending the data using the magnetic communication interface.

17. The method of claim 10, comprising:
establishing a peer network with one or more devices positioned on the charging surface using the magnetic communication interface.

18. The method of claim 10, comprising:
implementing the charging session with a device positioned on the charging surface, and
receiving charging status data from the device using the magnetic communication interface during the charging session.

19. A non-transitory computer-readable medium storing instructions that when executed facilitate performance of operations comprising:
receiving a charging parameter using a magnetic communication interface of a charging apparatus; and
generating a charging signal proximate a charging surface of the charging apparatus during a charging session based on the charging parameter using a magnetic charging element separate from the magnetic communication interface.

20. The non-transitory computer-readable medium of claim 19, wherein the operations comprise:
establishing a peer network with one or more devices positioned on the charging surface using the magnetic communication interface;
implementing the charging session with the one or more devices; and
receiving charging status data from the one or more devices using the magnetic communication interface during the charging session.
